(19) United States
(12) Patent Application Publication
(10) Pub. No.: US 2025/0373141 A1
(43) Pub. Date: Dec. 4, 2025

(54) POWER CONVERTING APPARATUS

(71) Applicant: HANWHA SOLUTIONS CORPORATION, Seoul (KR)

(72) Inventors: Il Kyu PARK, Seoul (KR); Seong Hun LEE, Seoul (KR); Seong Hun HA, Seoul (KR); Ju Hwan YUN, Seoul (KR)

(73) Assignee: HANWHA SOLUTIONS CORPORATION, Seoul (KR)

(21) Appl. No.: 19/214,774

(22) Filed: May 21, 2025

(30) Foreign Application Priority Data
May 28, 2024 (KR) 10-2024-0069048

(51) Int. Cl. H02M 1/00; H02M 7/02

(52) U.S. Cl. CPC H02M 1/0058; H02M 7/02

(57) ABSTRACT

A power converting apparatus includes a photovoltaic inverter configured to convert direct current power from a photovoltaic module into alternating current power, and a controller configured to control the photovoltaic inverter, wherein the photovoltaic inverter includes a first switcher configured to perform switching on the direct current power, a transformer having an input side connected to an output end of the first switcher, and a second switcher connected to an output side of the transformer, and the controller is configured to control at least one of a voltage and current of the first switcher and a voltage and current of the second switcher.

### CROSS-REFERENCE TO RELATED APPLICATION

This application is based on and claims priority under 35 U.S.C. § 119 to Korean Patent Application No. 10-2024-0069048, filed on May 28, 2024, in the Korean Intellectual Property Office, the disclosure of which is incorporated by reference herein in its entirety.

### BACKGROUND

### 1. Field

The disclosure relates to a power converting apparatus, and more particularly to, a power converting apparatus used in a photovoltaic system.

### 2. Description of the Related Art

Recently, while interest in eco-friendly energy technology has increased, the installation of solar power generation systems for generating energy by using sunlight has also increased. A solar power generation system is a system that collects solar energy through photovoltaic modules to produce electricity. The electricity produced in this way is supplied to the home's power grid to provide household electricity or is stored and used in a battery. Generating electricity through solar power generation systems is environmentally friendly and may save electricity bills in the long term, thereby gaining attention recently.

Generally, a plurality of photovoltaic (PV) modules are installed in a solar power generation system, and each PV module has one module-level power electronics (MLPE) or monitoring module installed on each panel thereof. Each MLPE includes a photovoltaic inverter that converts the generated energy, and the photovoltaic inverter generally has a dual active bridge (DAB) topology structure. To implement zero voltage switching (ZVS) in a photovoltaic inverter having a DAB structure, a current at a certain value or more must flow, but this may lead to a decrease in the efficiency of a power converting apparatus. Therefore, various studies have been conducted to strike a balance between zero voltage switching and power control and increase the efficiency of a power converting apparatus.

### SUMMARY

A technical problem to be solved by the disclosure is to provide a power converting apparatus that satisfies zero voltage switching by minimizing a phase difference between a first switcher and a second switcher.

Another technical problem to be solved by the disclosure is to provide a power converting apparatus that controls power by utilizing a phase difference between a first leg and a second leg of the first switcher.

In addition, the disclosure aims to provide a power converting apparatus with maximized efficiency by preventing transmission of unnecessary current.

To solve the above-described problem of the disclosure, a power converting apparatus according to an embodiment of the disclosure includes a photovoltaic inverter configured to convert direct current power from a photovoltaic module into alternating current power, and a controller configured to control the photovoltaic inverter, wherein the photovoltaic inverter includes a first switcher configured to perform switching on the direct current power, a transformer having an input side connected to an output end of the first switcher, and a second switcher connected to an output side of the transformer, and the controller is configured to control at least one of a voltage and current of the first switcher and a voltage and current of the second switcher.

In some embodiments, the first switcher may include a first switching element and a second switching element, which are connected in parallel to each other, and a third switching element and a fourth switching element, which are connected in series to the first switching element and the second switching element, respectively, and the input side of the transformer may be connected between a first node, which is between the first switching element and the third switching element, and a second node, which is between the second switching element and the fourth switching element.

In some embodiments, the second switcher may include a fifth switching element and a sixth switching element, which are connected in parallel to each other, and a seventh switching element and an eighth switching element, which are connected in series to the fifth switching element and the sixth switching element, respectively, and the output side of the transformer may be connected between a third node, which is between the fifth switching element and the seventh switching element, and a fourth node, which is between the sixth switching element and the eighth switching element.

In some embodiments, the second switcher may include a fifth switching element and a sixth switching element, which are connected in series to each other, and a first capacitor and a second capacitor, which are connected in series to each other, and the output side of the transformer may be connected between a third node, which is between the fifth switching element and the sixth switching element, and a fourth node, which is between the first capacitor and the second capacitor.

In some embodiments, the second switcher may include a fifth switching element, a sixth switching element, a seventh switching element, and an eighth switching element, which are connected in series to each other, and a first capacitor and a second capacitor, which are connected in series to each other, and the output side of the transformer may be connected between a third node, which is between the sixth switching element and the seventh switching element, and a fourth node, which is between the first capacitor and the second capacitor.

In some embodiments, the first switcher may include a first leg including the first switching element and the third switching element, which are connected in series to each other, and a second leg including the second switching element and the fourth switching element, which are connected in series to each other.

In some embodiments, the first switcher and the second switcher may switch with a first phase difference, the first leg and the second leg may switch with a second phase difference, and the controller may vary at least one of the first phase difference and the second phase difference.

In some embodiments, the controller may be configured to control an input voltage of the first switcher and an output voltage of the second switcher so that the first phase difference decreases.

In some embodiments, the photovoltaic inverter may be a string inverter connected to a photovoltaic module string or a micro inverter included in a photovoltaic module.

In some embodiments, the photovoltaic inverter may further include a resonant inductor connected between the transformer and the second switcher, and the controller may be configured to control a current of the first switcher, a current of the second switcher, and a leakage inductance of the resonant inductor so that the second phase difference decreases.

A photovoltaic system according to another aspect may include at least one photovoltaic module having a power converting apparatus.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram to describe the structure of a photovoltaic system according to an embodiment;

FIG. 2 is a diagram to describe the structure of a photovoltaic inverter according to an embodiment;

FIG. 3 is a diagram to describe the structure of a photovoltaic inverter according to an embodiment;

FIG. 4 is a diagram to describe the structure of a photovoltaic inverter according to an embodiment;

FIG. 5 is a diagram to describe waveforms of currents according to an input voltage of a first switcher and an output voltage of a second switcher;

FIG. 6 is a diagram to describe changes in current waveforms according to control by a controller;

FIG. 7 is a diagram illustrating a configuration of a plurality of photovoltaic module strings and a controller, according to an embodiment;

FIG. 8 is a diagram illustrating a configuration in which micro inverters are provided in a plurality of photovoltaic modules according to an embodiment; and

FIG. 9 is a diagram for reference in describing a power supply structure of a building in which a photovoltaic module is installed, according to an embodiment.

### DETAILED DESCRIPTION

Advantages and features of the disclosure and methods of achieving the same will be apparent with reference to embodiments and drawings described below in detail. The disclosure may, however, be embodied in many different forms and should not be construed as being limited to the embodiments set forth herein. The disclosure should be understood to include all transformations, equivalents, or substitutes included in the spirit and technical scope of the disclosure. The embodiments to be disclosed below are provided so that the disclosure will be complete and will fully convey the scope of the disclosure to those skilled in the art to which the disclosure pertains. In the description of the disclosure, if it is determined that a detailed description of a related known technology may obscure the gist of the disclosure, the detailed description is omitted.

The terms used in the application are used only to describe particular embodiments and are not intended to limit the disclosure. The phrases “in some embodiments” or “in an embodiment” in various places throughout the specification are not necessarily all referring to the same embodiment. Singular expressions include plural expressions, unless the context clearly indicates otherwise. In the application, it should be understood that terms such as “include” or “have” are intended to specify the presence of a feature, number, step, operation, component, part, or combinations thereof described in the specification, but do not exclude in advance the possibility of the presence or addition of one or more other features, numbers, steps, operations, components, parts, or combinations thereof.

Also, the connecting lines or connecting members between components shown in the drawings are only illustrative of functional connections and/or physical or circuit connections. In an actual device, connections between components may be represented by a variety of alternative or additional functional, physical, or circuit connections.

Embodiments may have various modifications and may have various forms, and some embodiments are illustrated in the drawings and described in detail. However, this is not intended to limit the embodiments to a specific disclosure form, but should be understood to include all modifications, equivalents, or substitutes included in the spirit and technical scope of the embodiments. The terms used in the specification are used only to describe embodiments and are not intended to limit the embodiments.

Unless otherwise defined, the terms used in embodiments have the same meaning as commonly understood by one of ordinary skill in the art to which the embodiments belong. Terms defined in commonly used dictionaries should be interpreted as having a meaning consistent with their meaning in the context of the relevant technology, and should not be interpreted in an idealized or overly formal sense, unless explicitly defined in embodiments.

The detailed description of the disclosure to be described below refers to the accompanying drawings which illustrate specific embodiments in which the disclosure may be practiced. The embodiments are described in sufficient detail to enable those skilled in the art to practice the disclosure. It should be understood that the various embodiments of the disclosure are different but are not necessarily mutually exclusive. For example, specific shapes, structures, and characteristics described herein may be modified and implemented from one embodiment to another without departing from the spirit and scope of the disclosure. It should also be understood that the positions or arrangements of individual components within each embodiment may be changed without departing from the spirit and scope of the disclosure. Accordingly, the detailed description set forth below is not intended to be limiting, and the scope of the disclosure should be accepted as encompassing the scope claimed in the claims and all scopes equivalent thereto. In the drawings, similar reference numerals represent identical or similar components throughout various aspects.

Hereinafter, various embodiments of the disclosure will be described in detail with reference to the attached drawings so that one of the ordinary skill in the art to which the disclosure pertains may easily practice the disclosure.

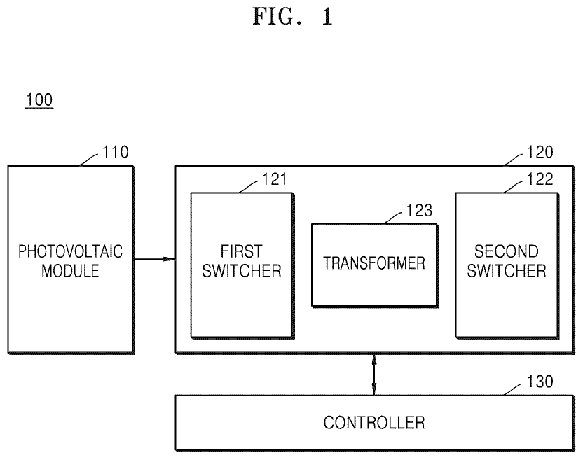

FIG. 1 is a diagram to describe the structure of a photovoltaic system according to an embodiment.

Referring to FIG. 1, a photovoltaic system 100 according to an embodiment of the disclosure may include a photovoltaic module 110 and a power converting apparatus. The power converting apparatus may include a photovoltaic inverter 120 and a controller 130. Unlike as shown in FIG. 1, the photovoltaic module 110 may be configured to include a power converting apparatus. The photovoltaic system 100 may include a plurality of photovoltaic modules 110, and the plurality of photovoltaic modules 110 may be interconnected to configure a photovoltaic module array. At this time, the plurality of photovoltaic modules 110 may be interconnected through a power line.

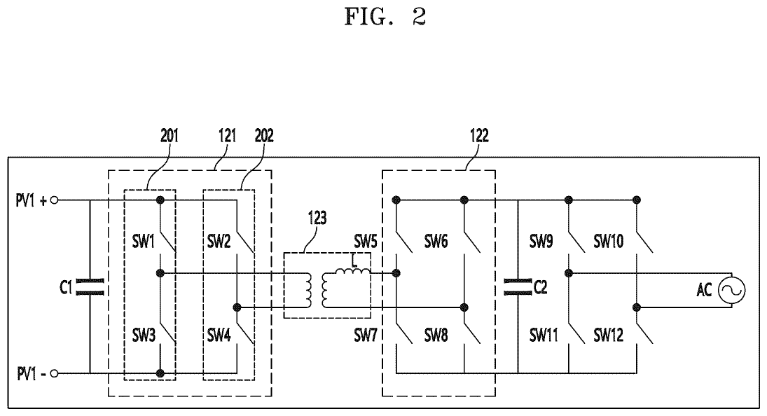

The photovoltaic inverter 120 may include a first switcher 121, a second switcher 122, and a transformer 123, and detailed descriptions thereof are given below with reference to FIGS. 2 to 4.

The photovoltaic inverter 120 may correspond one-to-one to a photovoltaic module 110 or a photovoltaic module array. The photovoltaic inverter 120 may convert energy generated through the photovoltaic module 110 or the photovoltaic module array into alternating current power. In some embodiments, the photovoltaic inverter 120 may sum up and convert energy generated from the plurality of photovoltaic modules 110 and the photovoltaic module array.

The controller 130 may control the photovoltaic inverter 120, and particularly, may control any one or more of the voltage and current of the first switcher 121 and the voltage and current of the second switcher 122. In some embodiments, the controller 130 may also be configured to be included in the photovoltaic inverter 120, unlike that shown in FIG. 1.

The disclosure proposes a method of maximizing the efficiency of a power converting apparatus by reducing peak current that may occur when controlling the photovoltaic inverter 120 for zero voltage switching. This is described below with reference to FIG. 2.

FIG. 2 is a diagram to describe the structure of a photovoltaic inverter according to an embodiment. In the following description, any portion that overlaps with the description with reference to FIG. 1 is omitted.

Referring to FIG. 2, the photovoltaic inverter 120 according to an embodiment of the disclosure may include the first switcher 121, the second switcher 122, and the transformer 123. At this time, the first switcher 121 may have a full-bridge structure, include a first switching element SW1 and a second switching element SW2, which are connected in parallel to each other, and include a third switching element SW3 and a fourth switching element SW4, which are connected in series to the first switching element SW1 and the second switching element SW2, respectively. That is, the first switching element SW1 and the third switching element SW3 may be connected in series to each other, and the second switching element SW2 and the fourth switching element SW4 may be connected in series to each other.

In some embodiments, an input side of the transformer 123 may be connected to the first switcher 121 between a first node, which is between the first switching element SW1 and the third switching element SW3, and a second node, which is between the second switching element SW2 and the fourth switching element SW4.

In some embodiments, the first switcher 121 may include a first leg 201 including the first switching element SW1 and the third switching element SW3, which are connected in series to each other, and a second leg 202 including the second switching element SW2 and the fourth switching element SW4, which are connected in series to each other.

In some embodiments, a capacitor C1 may be arranged at an input end of the first switcher 121.

The second switcher 122 may have a full-bridge structure, include a fifth switching element SW5 and a sixth switching element SW6, which are connected in parallel to each other, and include a seventh switching element SW7 and an eighth switching element SW8, which are connected in series to the fifth switching element SW5 and the sixth switching element SW6, respectively. That is, the fifth switching element SW5 and the seventh switching element SW7 may be connected in series to each other, and the sixth switching element SW6 and the eighth switching element SW8 may be connected in series to each other.

In some embodiments, an output side of the transformer 123 may be connected to the second switcher 122 between a third node, which is between the fifth switching element SW5 and the seventh switching element SW7, and a fourth node, which is between the sixth switching element SW6 and the eighth switching element SW8.

In some embodiments, a first capacitor C2 may be arranged at an output end of the second switcher 122.

The photovoltaic inverter 120 may further include a ninth switching element SW9 and an eleventh switching element SW11, which are connected in series to each other, and a tenth switching element SW10 and a twelfth switching element SW12, which are connected in series to each other.

In some embodiments, the photovoltaic inverter 120 may output alternating current power through a fifth node, which is between the ninth switching element SW9 and the eleventh switching element SW11, and a sixth node, which is between the tenth switching element SW10 and the twelfth switching element SW12.

The first to twelfth switching elements SW1 to SW12 in the photovoltaic inverter 120 may perform a turn-on or turn-off operation based on a photovoltaic inverter switching control signal from the controller 130, and accordingly, alternating current power having a certain frequency may be output. At this time, the certain frequency may be 60 Hz or 50 Hz, which is the same frequency as an alternating current frequency of a grid voltage, but is not limited thereto.

The photovoltaic inverter 120 according to an embodiment of the disclosure may further include a resonant inductor L connected between the transformer 123 and the second switcher 122. Accordingly, an inductor current flows based on a voltage difference between respective ends of the resonant inductor L, and the controller 130 may control converted power by controlling a phase difference between the respective ends of the resonant inductor.

The first to fourth switching elements SW1 to SW4 in the first switcher 121 may perform zero voltage switching (ZVS) and zero current switching (ZCS) by the resonant inductor L.

ZVS may mean performing switching in a state in which a voltage is 0 V by using the resonant inductor L to reduce a switching loss that occurs when switching elements in the first switcher 121 and the second switcher 122 included in the power converting apparatus are turned on or off.

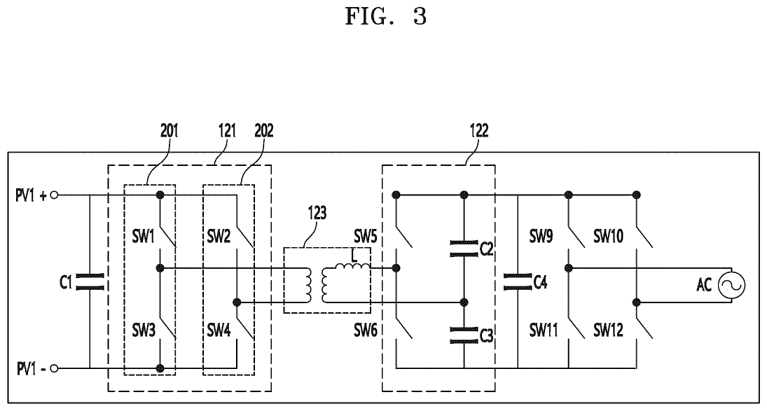

FIG. 3 is a diagram to describe the structure of a photovoltaic inverter according to an embodiment. In the following description, any portion that overlaps with the description with reference to FIGS. 1 and 2 is omitted.

Referring to FIG. 3, the photovoltaic inverter 120 according to an embodiment of the disclosure may include the first switcher 121, the second switcher 122, and the transformer 123. At this time, the first switcher 121 may have a full-bridge structure, include the first switching element SW1 and the second switching element SW2, which are connected in parallel to each other, and include the third switching element SW3 and the fourth switching element SW4, which are connected in series to the first switching element SW1 and the second switching element SW2, respectively. That is, the first switching element SW1 and the third switching element SW3 may be connected in series to each other, and the second switching element SW2 and the fourth switching element SW4 may be connected in series to each other.

In some embodiments, the input side of the transformer 123 may be connected to the first switcher 121 between a first node, which is between the first switching element SW1 and the third switching element SW3, and a second node, which is between the second switching element SW2 and the fourth switching element SW4.

In some embodiments, the first switcher 121 may include the first leg 201 including the first switching element SW1 and the third switching element SW3, which are connected in series to each other, and the second leg 202 including the second switching element SW2 and the fourth switching element SW4, which are connected in series to each other.

In some embodiments, the capacitor C1 may be arranged at an input end of the first switcher 121.

The second switcher 122 may have a half-bridge structure, include the fifth switching element SW5 and the sixth switching element SW6, which are connected in series to each other, and include the first capacitor C2 and a second capacitor C3, which are connected in series to each other.

In some embodiments, an output side of the transformer 123 may be connected to the second switcher 122 between a third node, which is between the fifth switching element SW5 and the sixth switching element, and a fourth node, which is between the first capacitor C2 and the second capacitor C3.

In some embodiments, a third capacitor C4 may be arranged at the output end of the second switcher 122.

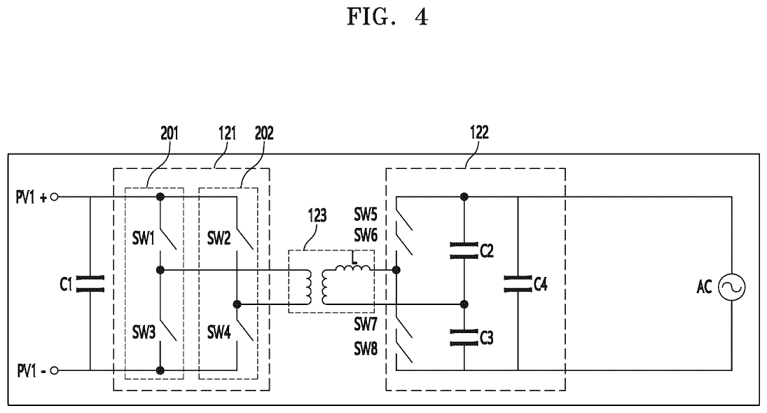

FIG. 4 is a diagram to describe the structure of a photovoltaic inverter according to an embodiment. In the following description, any portion that overlaps with the description with reference to FIGS. 1 to 3 is omitted.

Referring to FIG. 4, the photovoltaic inverter 120 according to an embodiment of the disclosure may include the first switcher 121, the second switcher 122, and the transformer 123. At this time, the first switcher 121 may have a full-bridge structure, include the first switching element SW1 and the second switching element SW2, which are connected in parallel to each other, and include the third switching element SW3 and the fourth switching element SW4, which are connected in series to the first switching element SW1 and the second switching element SW2, respectively. That is, the first switching element SW1 and the third switching element SW3 may be connected in series to each other, and the second switching element SW2 and the fourth switching element SW4 may be connected in series to each other.

In some embodiments, the input side of the transformer 123 may be connected to the first switcher 121 between a first node, which is between the first switching element SW1 and the third switching element SW3, and a second node, which is between the second switching element SW2 and the fourth switching element SW4.

In some embodiments, the first switcher 121 may include the first leg 201 including the first switching element SW1 and the third switching element SW3, which are connected in series to each other, and the second leg 202 including the second switching element SW2 and the fourth switching element SW4, which are connected in series to each other.

In some embodiments, the capacitor C1 may be arranged at the input end of the first switcher 121.

The second switcher 122 may have a half-bridge structure, include the fifth switching element SW5, the sixth switching element SW6, the seventh switching element SW7, and the eighth switching element SW8, which are connected in series to each other, and include the first capacitor C2 and the second capacitor C3, which are connected in series to each other.

In some embodiments, the output side of the transformer 123 may be connected to the second switcher 122 between a third node, which is between the fifth switching element SW5 and the seventh switching element SW7, and a fourth node, which is between the first capacitor C2 and the second capacitor C3.

In some embodiments, the third capacitor C4 may be arranged at the output end of the second switcher 122.

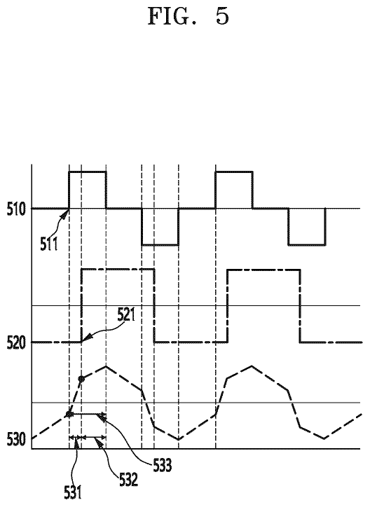

FIG. 5 is a diagram to describe waveforms of currents according to an input voltage of a first switcher and an output voltage of a second switcher. In the following description, any portion that overlaps with the description with reference to FIGS. 1 to 4 is omitted.

Referring to FIG. 5, the controller 130 may calculate a current configured to perform ZVS, based on a size of current between a switching section 511 of a voltage 510 of the first switcher 121 and a switching section 521 of a voltage 520 of the second switcher 122.

$$\frac{1}{2} {LI}_{Pri}^{2} = \frac{1}{2} {{C}_{Pri}^{2} ( {VP}_{V} \times N )}^{2} \qquad [ Equation 1 ]$$

$${I}_{Pri} = {V}_{PV} \times N \times \sqrt{\frac{{C}_{Pri}}{L}} \qquad [ Equation 2 ]$$

The controller 130 may calculate a current I_{Pri} of the first switcher 121, which is configured to perform ZVS, based on equations 1 and 2. At this time, C_{Pri} may mean an input current input to the first switcher 121, VPv may mean an input voltage input to the first switcher 121, N may mean a turns ratio, and L may mean a leakage inductance of a resonant inductor.

$$\frac{1}{2} {LI}_{sec}^{2} = \frac{1}{2} {C}_{sec} {V}_{sec}^{2} \qquad [ Equation 3 ]$$

$${I}_{sec} = {V}_{sec} \times \sqrt{\frac{{C}_{sec}}{L}} \qquad [ Equation 4 ]$$

The controller 130 may calculate a current I_{sec} of the second switcher 122 to perform ZVS, based on equations 3 and 4. At this time, may mean an input current input to the second switcher 122, V_{sec} may mean an input voltage input to the second switcher 122, and L may mean a leakage inductance of a resonant inductor.

$$dT = L \frac{dl}{V} \qquad [ Equation 5 ]$$

The controller 130 may calculate a time dT required to reach the current I_{sec} of the second switcher 122 from the current I_{Pri} of the first switcher 121, which is configured to perform ZVS, based on equation 5. At this time, V may mean a difference between a switching voltage of the first switcher 121 and a switching voltage of the second switcher 122, dl may mean a difference between the current I_{Pri} of the first switcher 121 and the current I_{sec} of the second switcher 122, which is configured to perform ZVS, and L may mean a leakage inductance of a resonant inductor.

$$G min = dT \times Fsw \qquad [ Equation 6 ]$$

The controller 130 may calculate a first phase difference (G) 531, based on equation 6. In detail, the first phase difference (G) 531 may mean a difference between the phase of the first switcher 121 and the phase of the second switcher 122, and the controller 130 may calculate the first phase difference (G) 531 through equation 6 and control an input or output voltage of the first switcher 121 and an input or output voltage of the second switcher 122 so that the first phase difference 531 decreases.

$${I}_{AC \_ Peak} = \frac{{V}_{sec}}{4 FL} ( - 2 {G}^{2} + G + W - 2 {W}^{2} ) \qquad [ Equation 7 ]$$

The controller 130 may calculate a second phase difference (W) 532, based on equation 7. In detail, the second phase difference (W) 532 may mean a difference between the phase of the first leg 201 and the phase of the second leg 202, and the controller 130 may calculate the second phase difference (W) 532 through equation 7 and control the current of the first switcher 121, the current of the second switcher 122, and the leakage inductance (L) of a resonant inductor so that the second phase difference (W) 532 decreases.

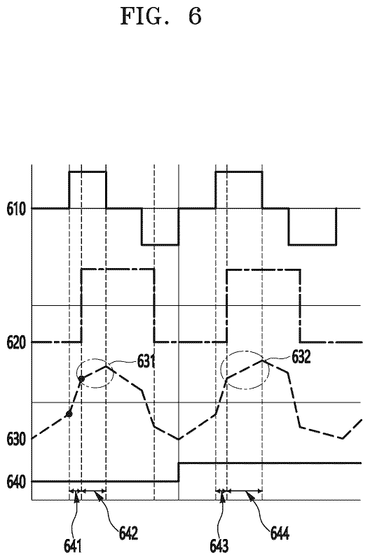

FIG. 6 is a diagram to describe changes in current waveforms according to control by a controller. In the following description, any portion that overlaps with the description with reference to FIGS. 1 to 5 is omitted.

Referring to FIG. 6, the controller 130 may calculate a first phase difference (G) 641 and a second phase difference (W) 642, based on equations 1 to 7, and may control the first switcher 121, the second switcher 122, and the transformer 123 so that the first phase difference (G) 641 becomes a minimum value 643. In detail, the controller 130 may set the first phase difference (G) 641 and the second phase difference (W) 642 to preset initial values, and may check whether the first phase difference (G) 641 and the second phase difference (W) 642 satisfy ZVS. In case that the first phase difference (G) 641 and the second phase difference (W) 642 do not satisfy ZVS, the controller 130 may calculate a minimum value at which the first phase difference (G) 641 and the second phase difference (W) 642 satisfy ZVS, based on equations 1 to 7. The controller 130 may control switching signals of the first switcher 121 and the second switcher 122 based on the calculated first phase difference (G) 641 and second phase difference (W) 642, and may control the currents of the first switcher 121 and the second switcher 122. For example, the controller 130 may control the current of the first switcher 121 to become 0 when the first to fourth switching elements SW1 to SW4 of the first switcher 121 are turned on or off. In some embodiments, the controller 130 may control the current of the second switcher 122 to become 0 when the fifth to eighth switching elements SW5 to SW8 of the second switcher 122 are turned on or off.

That is, the controller 130 may calculate a current for discharging parasitic capacitors of the first switcher 121 and the second switcher 122 by feeding back input and output voltages, which change in real-time. In some embodiments, in case that the first phase difference (G) becomes the minimum value 643 under control by the controller 130, a time required to increase a current may be reduced, and a value of a peak current may be reduced, and thus a loss of the power converting apparatus may be reduced to increase the efficiency.

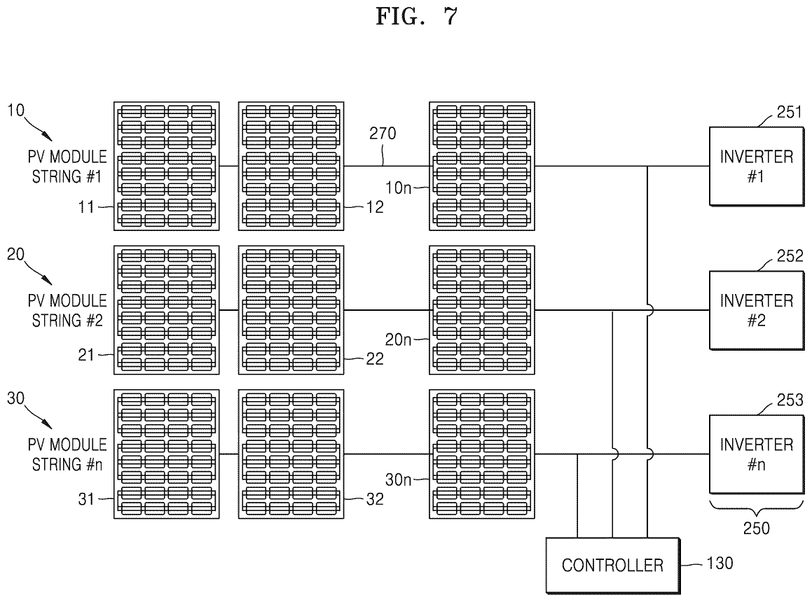

FIG. 7 is a diagram illustrating a configuration of a plurality of photovoltaic module strings and a controller, according to an embodiment.

As shown in FIG. 7, a plurality of photovoltaic modules 11 to 10n, 21 to 20n, and 31 to 30n may be interconnected to configure photovoltaic module strings 10, 20, and 30. The plurality of photovoltaic modules may be connected to a power line 270.

Each photovoltaic module string may be connected to a photovoltaic inverter 250 including first to third photovoltaic inverters 251 to 253. The photovoltaic inverter 250 may convert energy generated through a photovoltaic module string into alternating current power.

In some embodiments, each of a plurality of photovoltaic module strings may be connected to the controller 130 to transmit and receive data. A plurality of photovoltaic modules may transmit and receive data through the controller 130 and power line communication (PLC).

The PLC is a communication method that transmits data by using a power line (cable) supplying electricity. The PLC is a technology that communicates data by carrying the data on a frequency signal via a power line supplying electricity. The PLC may be divided into high-speed and low-speed based on speed, and may be divided into high-voltage and low-voltage based on voltage. For example, a home photovoltaic module and a device may communicate by using a power signal of 50 Hz to 60 Hz. For example, in another embodiment, a different frequency band may be used.

A first photovoltaic module string 10 may include a plurality of photovoltaic modules 11 to 10n of a first group. In some embodiments, the first photovoltaic module string 10 may be connected to the first photovoltaic inverter 251.

A second photovoltaic module string 20 may include a plurality of photovoltaic modules 21 to 20n of a second group, which are connected in series to each other. In some embodiments, the second photovoltaic module string 20 may be connected to the second photovoltaic inverter 252.

A third photovoltaic module string may include a plurality of photovoltaic modules 31 to 30n of a third group, which are connected in series to each other. In some embodiments, the third photovoltaic module string 30 may be connected to the third photovoltaic inverter 253.

In the drawing, the photovoltaic module string is shown as a plurality of photovoltaic modules connected in series, but may also include photovoltaic modules connected in parallel.

The plurality of photovoltaic modules 11 to 10n, 21 to 20n, and 31 to 30n may each be connected to a converter (now shown), and a plurality of converters may be connected to the photovoltaic inverter 250.

The photovoltaic inverter 250 and the controller 130 may be connected to the plurality of photovoltaic modules and the photovoltaic module string through the same power line 270.

The photovoltaic inverter 250 may sum up and convert energy generated from the plurality of photovoltaic modules and the photovoltaic module string.

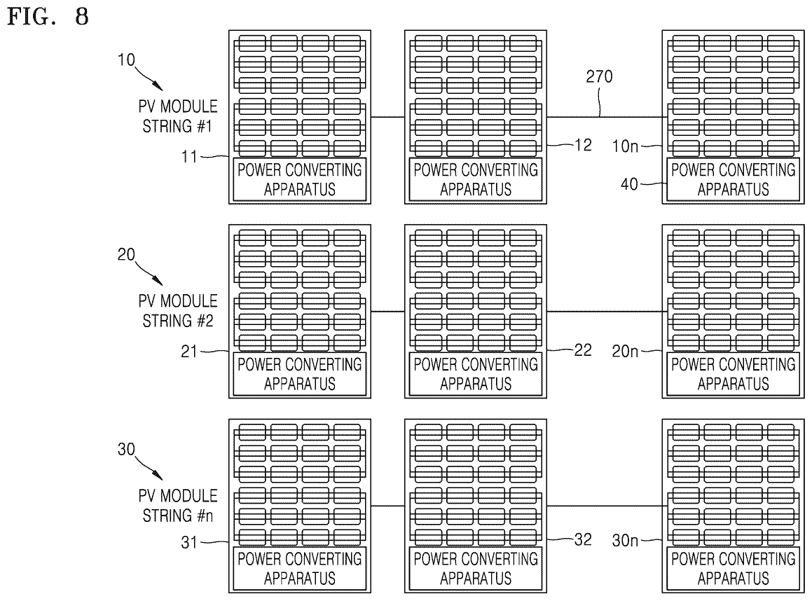

FIG. 8 is a diagram illustrating a configuration in which micro inverters are provided in a plurality of photovoltaic modules according to an embodiment. In the following description, any portion that overlaps with the description with reference to FIGS. 1 to 7 is omitted.

As shown in FIG. 8, a plurality of photovoltaic modules 11 to 10n, 21 to 20n, and 31 to 30n may each include a power converting apparatus 40. At this time, the power converting apparatus 40 may be a module level power electronics (MLPE). For example, in case that the photovoltaic system 100 is a system based on alternating current power (AC), the MLPE may include a micro inverter, and in case that the photovoltaic system 100 is a system based on direct current power (DC), the MLPE may include an optimizer.

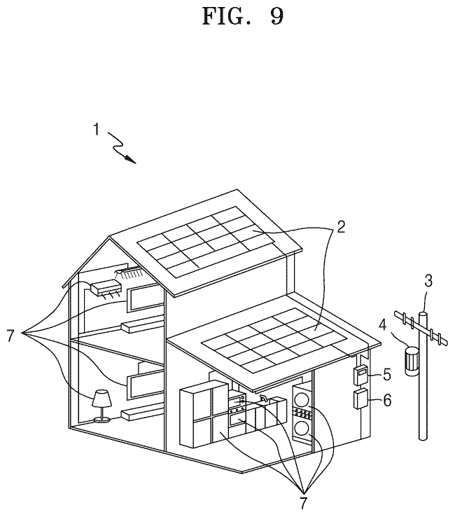

FIG. 9 is a diagram for reference in describing a power supply structure of a residential building in which a photovoltaic module is installed, according to an embodiment.

As shown in FIG. 9, a photovoltaic module 2 may be installed on the roof of a building to generate energy.

A photovoltaic inverter 6 may convert energy of the photovoltaic module 2 to supply generated power to a building 1.

Commercial power transmitted through an electric pole 3 may be supplied to a building through a transformer 4.

A plurality of home appliances 7 may operate by selectively receiving at least any one of commercial power or generated power of the photovoltaic module 2. A power meter 5 may measure an amount of power consumed by the building 1.

In some embodiments, in case that a separate energy storage system (ESS) is provided, energy of the photovoltaic module 2 may be stored in the ESS.

In case that a plurality of photovoltaic modules 2 are connected to each other, a photovoltaic module string may be configured. A photovoltaic module string is an assembly of a plurality of photovoltaic modules and may include one output terminal.

The photovoltaic module 2 may include an MLPE device.

The MLPE device controls power conversion in units of photovoltaic modules and may optimize the generated energy by including an optimizer. The MLPE device may include a monitoring function to monitor the status or amount of power generation of a photovoltaic module and transmit data to the outside.

In some embodiments, the MLPE device may include a rapid shutdown (RSD) function to stop an operation of a photovoltaic module according to a degree of failure.

The photovoltaic module 2 may include a monitoring device that monitors the status or amount of power generation of a photovoltaic module or an RSD device that performs a shutdown function.

In some embodiments, at least one of the plurality of photovoltaic modules and the MLPE device may include a communication module for power line communication.

According to an embodiment of the disclosure, a current for discharging a parasitic capacitor of a switching element may be calculated in real-time by feeding back input and output voltages in real-time.

According to an embodiment of the disclosure, zero voltage switching may be satisfied by minimizing the phase difference between a first switcher and a second switcher.

In addition, power may be controlled by utilizing the phase difference between a first leg and a second leg of the first switcher.

Also, there is an effect of maximizing efficiency by preventing unnecessary current transmission and reducing peak current.

The description of the specification as set forth above is for illustrative purposes only, and one of ordinary skill in the art to which the contents of the specification pertain will understand that the disclosure may be easily modified into other specific forms without changing the technical idea or essential characteristics of the disclosure. Therefore, it should be understood that the embodiments described above are exemplary in all respects and not limiting. For example, each component described as a single entity may be implemented in a distributed manner, and likewise, components described as distributed may be implemented in a combined manner.

Unless there is an explicit description or contradiction of the order of the operations constituting a method according to the disclosure, the operations may be performed in any suitable order. The disclosure is not necessarily limited to the order in which the above operations are described. Any use of examples or terms (e.g., “etc.”) In some embodiments is merely intended to illustrate the disclosure in more detail and is not intended to limit the scope of the disclosure by virtue of such examples or terms, unless otherwise limited by the claims. Also, those skilled in the art will appreciate that various modifications, combinations and variations may be made according to design conditions and factors within the scope of the appended claims or their equivalents.

Therefore, the idea of the disclosure should not be limited to the embodiments described above, and not only the scope of the patent claims described below but also all scopes equivalent to or equivalently modified from the scope of the patent claims are included in the scope of the idea of the disclosure.

What is claimed is:

1. A power converting apparatus comprising:
a photovoltaic inverter configured to convert direct current power from a photovoltaic module into alternating current power; and
a controller configured to control the photovoltaic inverter,
wherein the photovoltaic inverter comprises:
a first switcher configured to perform switching on the direct current power;
a transformer having an input side connected to an output end of the first switcher; and
a second switcher connected to an output side of the transformer, and
the controller is configured to control at least one of a voltage and current of the first switcher and a voltage and current of the second switcher.

2. The power converting apparatus of claim 1, wherein the first switcher comprises:
a first switching element and a second switching element, which are connected in parallel to each other; and
a third switching element and a fourth switching element, which are connected in series to the first switching element and the second switching element, respectively, and
the input side of the transformer is connected between a first node, which is between the first switching element and the third switching element, and a second node, which is between the second switching element and the fourth switching element.

3. The power converting apparatus of claim 1, wherein the second switcher comprises:
a fifth switching element and a sixth switching element, which are connected in parallel to each other; and
a seventh switching element and an eighth switching element, which are connected in series to the fifth switching element and the sixth switching element, respectively, and
the output side of the transformer is connected between a third node, which is between the fifth switching element and the seventh switching element, and a fourth node, which is between the sixth switching element and the eighth switching element.

4. The power converting apparatus of claim 1, wherein the second switcher comprises:
a fifth switching element and a sixth switching element, which are connected in series to each other; and
a first capacitor and a second capacitor, which are connected in series to each other, and
the output side of the transformer is connected between a third node, which is between the fifth switching element and the sixth switching element, and a fourth node, which is between the first capacitor and the second capacitor.

5. The power converting apparatus of claim 1, wherein the second switcher comprises:
a fifth switching element, a sixth switching element, a seventh switching element, and an eighth switching element, which are connected in series to each other; and
a first capacitor and a second capacitor, which are connected in series to each other, and
the output side of the transformer is connected between a third node, which is between the sixth switching element and the seventh switching element, and a fourth node, which is between the first capacitor and the second capacitor.

6. The power converting apparatus of claim 2, wherein the first switcher comprises:
a first leg comprising the first switching element and the third switching element, which are connected in series to each other; and
a second leg comprising the second switching element and the fourth switching element, which are connected in series to each other.

7. The power converting apparatus of claim 6, wherein
the first switcher and the second switcher switch with a first phase difference,
the first leg and the second leg switch with a second phase difference, and
the controller varies at least one of the first phase difference and the second phase difference.

8. The power converting apparatus of claim 7, wherein the controller is configured to control an input voltage of the first switcher and an output voltage of the second switcher so that the first phase difference decreases.

9. The power converting apparatus of claim 7, wherein the photovoltaic inverter further comprises a resonant inductor connected between the transformer and the second switcher,
the controller is configured to control a current of the first switcher, a current of the second switcher, and a leakage inductance of the resonant inductor so that the second phase difference decreases.

10. The power converting apparatus of claim 1, wherein the photovoltaic inverter is a string inverter connected to a photovoltaic module string or a micro inverter comprised in a photovoltaic module.

11. A photovoltaic system comprising at least one photovoltaic module having the power converting apparatus of claim 1.
